(19) United States
(12) Patent Application Publication
(10) Pub. No.: US 2005/0024289 A1
(43) Pub. Date: Feb. 3, 2005

(54) Rigid radome with polyester-polyarylate fibers and a method of making same

(76) Inventors: Marvin I. Fredberg, Stoughton, MA (US); Peter H. Sheahan, Groton, MA (US); Sharon A. Elsworth, Mason, NH (US); Kaichang Chang, Northboro, MA (US); Kevin O'Donnell, Berlin, MA (US); Brian Cavener, Andover, MA (US)

Correspondence Address: Iandiorio & Teska, 260 Bear Hill Road, Waltham, MA, 02451-1018, US

(21) Appl. No.: 10/621,155

(22) Filed: Jul. 16, 2003

(51) Int. Cl. H01Q 1/42

(52) U.S. Cl. 343/872

(57) ABSTRACT

A radome or feedome comprising at least one rigid panel including composite material having polyester-polyarylate fibers in a rigid resin matrix material.

### RELATED APPLICATIONS

This application is related to the U.S. patent application entitled RADOME WITH POLYESTER-POLYARYLATE FIBERS AND A METHOD OF MAKING SAME, filed on even date herewith and which is hereby incorporated herein by reference.

### FIELD OF THE INVENTION

This invention relates to a high strength rigid radome or feedome with polyester-polyarylate fibers which reduce radio frequency transmission losses while providing structural strength.

### BACKGROUND OF THE INVENTION

Rigid radomes for radar or communications antennas serve as protection from thermal distortions, sunlight, rain, and other elements.

Most conventional rigid radomes are manufactured using a system of composite materials. The common material used for rigid radomes and feedomes is glass or quartz reinforcement fibers in a rigid matrix material such as epoxy polyester, cyanate ester, vinyl esters, polybutadiene, or other suitable rigid resin matrix materials. While providing adequate structural integrity, existing radomes and feedomes exhibit radio frequency (RF) transmission losses in both transmit and receive modes. As a result, the required transmission power of the radar or communications subsystems must be increased, often at significant expense.

Given the requirements for structural Integrity and low RF transmission losses, it then becomes necessary to balance the mechanical and electrical composite material properties and select from among available material combinations to satisfy the radio frequency electrical performance requirements while also meeting the structural demands of the radome.

### BRIEF SUMMARY OF THE INVENTION

It is therefore an object of this invention to provide a high strength rigid radome or feedome with reduced radio frequency (RF) transmission losses, thus providing increased RF receiving sensitivity, and allowing reduced RF transmitted power.

It is a further object of this invention to provide such a high strength rigid radome that satisfies radar electrical performance requirements while also meeting structural demands.

It is a further object of this invention to provide such a high strength rigid radome that reduces the power requirements and cost of the systems protected by the radome.

The invention results from the realization that a high strength rigid radome with low RF loss and high structural and mechanical integrity is achieved by utilizing polyester-polyarylate fibers in a rigid matrix material in place of glass or quartz fibers or other currently known or used materials.

This invention features a radome or feedome comprising at least one rigid panel including composite material having polyester-polyarylate fibers in a rigid resin matrix material. The rigid panel may include a first composite material skin having polyester-polyarylate fibers in a rigid resin matrix material. The rigid panel may include a second opposing composite material skin having polyester-polyarylate fibers in a rigid resin matrix material. There may be a core between the first and second composite material skins. The core may be a low density material. The rigid resin matrix material may be epoxy, polyester, polybutadiene, cyanate ester, vinyl ester, or a blend of at least two of: epoxy, polyester, polybutadiene, cyanate ester, or vinyl ester. The polyester-polyarylate fibers may be between 100 denier and 5000 denier.

This invention further features a radome or feedome comprising at least one rigid panel including composite material skins with polyester-polyarylate fibers in a rigid resin matrix material and a core therebetween.

This invention also features a rigid radome or feedome with reduced radio frequency loss comprising a first skin including polyester-polyarylate fibers in a rigid resin matrix material, a second skin including polyester-polyarylate fibers in a rigid resin matrix material, and a core disposed between the first skin and the second skins. The core may be a low density material and the rigid resin matrix material may be epoxy, polyester, polybutadiene, cyanate ester, vinyl ester, or a blend of at least two of: epoxy, polyester, polybutadiene, cyanate ester, and vinyl ester. The polyester-polyarylate fibers may be between 100 denier and 5000 denier.

This invention also features a method of producing a radome or feedome comprising forming at least one rigid panel including composite material having polyester-polyarylate fibers in a rigid resin matrix material. The at least one rigid panel may include a composite material skin having polyester-polyarylate fibers in a rigid resin matrix material.

This invention further features a method of producing a radome or feedome by forming first and second skins comprised of polyester-polyarylate fibers in a rigid resin matrix, disposing a core between the first and the second skins, and bonding skins to the core.

### BRIEF DESCRIPTION OF THE DRAWINGS

Other objects, features and advantages will occur to those skilled in the art from the following description of a preferred embodiment and the accompanying drawings, in which:

FIG. 1 is a schematic view of a typical ground-based rigid radome;

FIG. 2 is a schematic view of a rigid naval radome;

FIG. 3 is a schematic view of an aircraft blister radome;

FIG. 4 is a schematic view of a feedome;

FIG. 5 is a schematic cross-sectional view of a section of a prior art rigid radome sandwich construction; and

FIG. 6 is a schematic cross-sectional partial view of a panel of a radome in accordance with the present invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

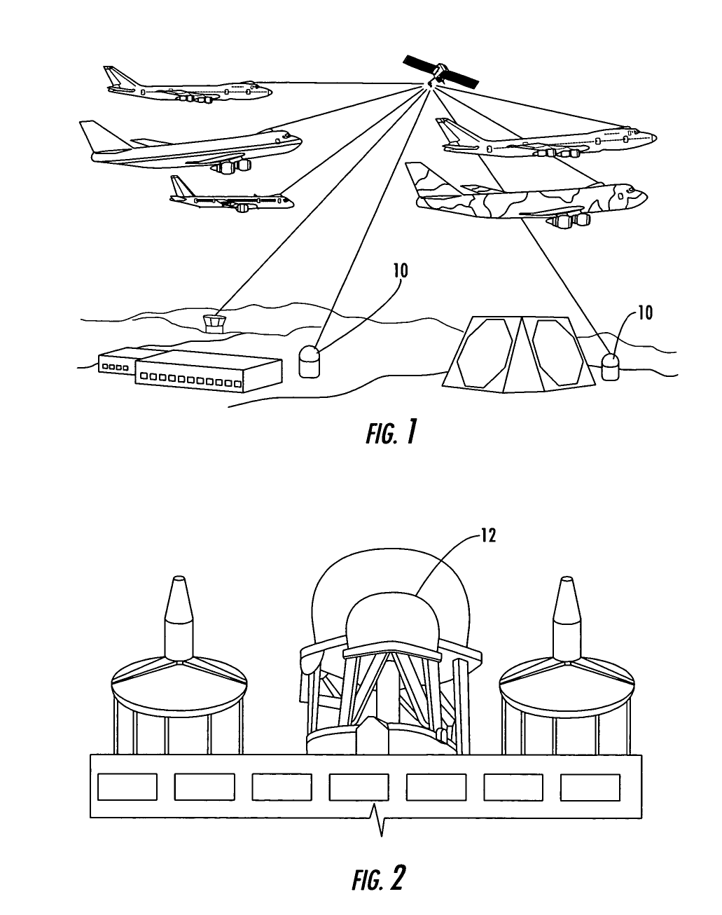

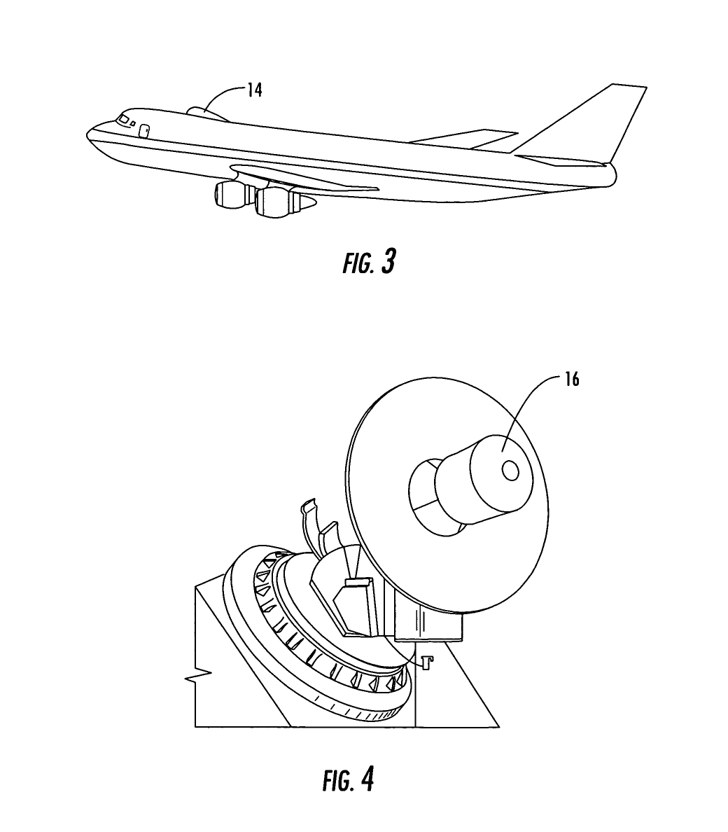

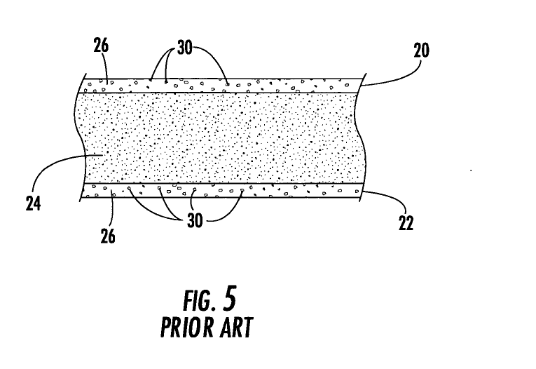

As disclosed in the Background section above, rigid radomes are commonly used to provide environmental protection for radar and communications equipment. Typical rigid radomes include ground-based radomes 10, FIG. 1; naval radomes 12, FIG. 2; and aircraft blister radomes 14, FIG. 3. Feedomes 16, FIG. 4, typically provide protection for only the feed portion of a radar or communications system antenna.

The state of the art in composite radome designs relies on composite technology, namely glass or quartz fibers in a rigid matrix material in order to withstand natural and induced environmental conditions. Kevlar is another material sometimes used. A typical rigid radome is formed of panels having a sandwich construction, FIG. 5, with two composite skins or membranes 20 and 22 which are thin, generally ranging from about 0.015 inches thick to 0.25 inches thick, with a low density material core 24 therebetween, usually ranging from about 0.25 inches to several inches thick. Skins and core thicknesses are typically varied depending on RF requirements. In addition to sandwich construction, radomes and feedomes are also known to be constructed from a single layer skin of composite, with no core. Thickness may also vary from very thin, for example 0.010 inches, to several inches.

In conventional rigid radomes, the skin or skins 20, 22 are manufactured using a system of composite materials, commonly a matrix material 26, FIG. 5, such as epoxy, polyester, vinyl ester, pqlybutadiene, cyanate ester or other suitable rigid resin matrix material. The matrix material adheres, encases, penetrates, and binds the reinforcement fibers 30 therein, locking the fibers together to form rigid skin 20. One drawback of conventional rigid radomes made this way is the resulting RF transmission loss and loss of receiving sensitivity. To account for these losses, the power of the system protected by the radome must be increased, resulting in added costs or system performance must be sacrificed.

For minimum RF losses, it is advantageous for the radome membrane material to have a low dielectric constant and loss tangent, and to be of appropriate thickness. The rigid radome of the subject invention improves the shortcomings of prior rigid radomes made with conventional materials by utilizing polyester-polyarylate fibers which provide mechanical strength and stiffness combined with decreased RF transmission loss because polyester-polyarylate fibers have a lower dielectric constant than quartz or glass.

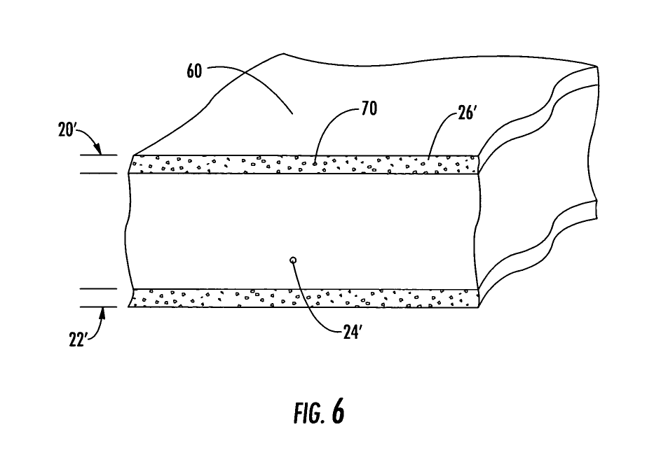

In accordance with this invention, reinforcement fibers 70, FIG. 6, of radome panel 60 are polyester-polyarylate fibers instead of quartz or glass fibers. One provider of polyester-polyarylate material is Celanese Acetate LLC which sells “Vectran” fibers. Vectran® is a registered trademark of Celenese LLC. Vectran® is commonly produced as a 1500 denier fiber which can readily be woven or knitted into a fabric. Other deniers from 200 to 3750 denier can also be purchased.

Table 1 below shows sample rigid sandwich radome RF loss comparisons for identically constructed rigid radome panels with 0.015 inch thick skins and a 1.5 inch low density foam core. Table 1 compares the RF performance of: quartz fiber in a cyanate ester matrix; quartz fiber in a polybutadiene matrix; polyester-polyarylate fibers in a cyanate ester matrix; and polyester-polyarylate fibers in a polybutadiene matrix.

TABLE 1

| | | | % Improved |
|---|---|---|---|
| Radome Composite | RF Loss (dB) | | Performance RF |
| Materials | Quartz | Polyester-polyarylate | Performance |
| Cyanate Ester | 0.36 | 0.21 | 41 |
| Polybutadiene | 0.30 | 0.20 | 33 |

As shown in Table 1, the rigid radome of this invention containing polyester-polyarylate fibers showed 41% improved RF performance over quartz fibers when in a cyanate ester matrix, and a 33% improved RF performance over quartz when in a polybutadiene matrix. Additionally, the polyester-polyarylate fiber of this invention has characteristics of low water absorption (<0.1%) which precludes deterioration of RF performance characteristics due to water absorption. By way of comparison Kevlar®, which was used in rigid fiber radomes for aircraft applications, demonstrated water absorption of 3.7% (at 72° F. and 65% relative humidity) and exhibit increased RF loss due to water as well as matrix failures due to Kevlar® swelling. Kevlar® is a registered trademark of DuPont corporation.

Overall, the trend toward higher frequencies and wider, multi-band, coverage renders polyester-polyarylate as highly suitable reinforcement fiber in composite radomes, to provide superior RF transmission performance.

Insofar as strength is a factor, a radome constructed with polyester-polyarylate fibers will not be structurally equivalent to one fabricated with quartz on a “one-to-one” basis because the strength of polyester-polyarylate fibers is slightly less than quartz or glass. The mechanical properties for polyester-polyarylate fibers are not so low as to preclude it as a structural option. If the radome design under consideration, were driven by strength, more polyester-polyarylate fibers may be required to offset a lower tensile strength. For a radome which is sensitive to buckling, RF performance enhancement using polyester-polyarylate fibers (vs. quartz or glass) is probable because the tensile modulus of polyester-polyarylate fibers is only marginally lower than quartz, but the dielectric constant is substantially lower. Here, the benefits of lower dielectric constant, outweigh the marginal thickness increase.

Table 2 below shows fiber properties comparison between glass quartz and polyester-polyarylate fibers:

TABLE 2

| | | | | Polyester- |
|---|---|---|---|---|
| | | | S-2 Glass | Polyarylate |
| Property | Quartz Fiber | E Glass | Fiber | Fiber |
| Tensile | 850 | 500 | 665 | 412 |
| Strength, 10³ psi | | | | |
| Tensile | 11 | 10.5 | 13 | 9 |
| Modulus, 10⁶ psi | | | | |
| Elongation, % | 7.7 | 4.5 | 5.4 | 3.3 |
| Dielectric | 3.74 | 6.1 | 5.21 | 2.09 |
| Constant @ 10 GHz | | | | |
| Loss Tangent @ | 0.00025 | 0.004 | 0.0068 | 0.003 |
| 10 GHz | | | | |

Table 3 shows a comparison of various radome constructions compared to a quartz fiber radome baseline.

TABLE 3

| | | | Modulus x | |
|---|---|---|---|---|
| | | | Inertia | |
| | | Material | (normalized) | |
| | | With | (core shear | |
| | | Cyanate | contribution | One Way |
| | | Ester | ignored for | Loss @ |
| | Construction | Matrix | simplicity) | 10 GHz |
| Baseline | 1.530 thick w/ | Quartz | 1.0 | 0.36 dB |
| | 0.015″ skins | | | |
| Equivalent | 1.530 thick w/ | Polyester- | 0.82 | 0.21 dB |
| Construction | 0.015″ skins | Polyarylate | | |
| Equivalent | 1.535 thick w/ | Polyester- | 1.0 | 0.26 dB |
| Stiffness | 0.0175″ skins | Polyarylate | | |
| Equivalent | 1.552 thick w/ | Polyester- | 1.78 | 0.36 dB |
| Electrical | 0.026″ skins | Polyarylate | | |
| Performance | | | | |

For radome designs that are stiffness driven, such as where shell buckling is a concern, polyester-polyarylate fiber reinforcement is also advantageous when RF loss is considered. Polyester-polyarylate stiffness is comparable to quartz or glass but the lower dielectric constant decreases the RF loss. For stiffness, a comparison of the product of the skin modulus times the rigid radome panel inertia was considered (the low density foam core shear stiffness contribution was ignored), with the results shown in Table 3. A “one-for-one” replacement of quartz fiber with polyester-polyarylate fibers would result in an 18% stiffness reduction due to the lower modulus (Table 3, line 2) or 82% of the baseline case, but the RF loss would be reduced from 0.36 dB to 0.21 dB, a 41% reduction in loss. Theoretically, increasing each skin thickness by 0.0025 inches (total thickness increase=0.005 inches) would compensate for the stiffness loss (Table 3, line 3) since the modulus times the inertia equals the baseline value. For this case, the RF loss would be reduced from 0.36 dB to 0.26 dB, a 27% decrease in RF loss, but at equivalent stiffness. If equivalent electrical performance were required, a radome with 0.026 inch skins could be used and the stiffness would be improved by greater than 75% (Table 3, line 4).

In summary, when compared to quartz fibers in cyanate ester, a polyester-polyarylate radome design with equivalent stiffness reduces RF loss 27% (Table 3, line 3). With equivalent electrical performance (Table 3, line 4), a polyester-polyarylate fiber radome design provides a 78% increase in stiffness and stability. While the example provided addresses sandwich radome construction, a single skin radome can derive similar benefits. The lower dielectric constant of polyester-polyarylate fibers coupled with good mechanical properties provides a previously unknown option for radome designs.

One radome in accordance with this invention includes rigid panel 60, FIG. 6 made of a composite material having polyester-polyarylate fibers 70 in a rigid resin matrix material 26′. Each panel typically includes composite material skins 20′ and 22′ having polyester-polyarylate fibers 70 disposed in epoxy, polyester, vinyl ester, polybutadiene or cyanate ester, or any blend or combination of these, or other suitable matrix 26′ and low density core 24′ therebetween.

A radome or feedome of this invention can be manufactured as a single panel, or by forming a number of rigid panels 60, FIG. 6 made of composite material having polyester-polyarylate fibers 70 in a rigid resin matrix material 26′ made of epoxy, polyester, polybutadiene or cyanate ester. Each panel typically includes composite material skins 20′ and 22′ having polyester-polyarylate fibers 70 in a rigid resin matrix 26′ and low density core 24′ therebetween. A radome or feedome of this invention can also be manufactured as a single panel, or by forming rigid panels 60 including composite material skins 20′ and 22′ having polyester-polyarylate fibers 70 in a rigid resin matrix 26′, without the use of low density core 24′. Polyester-polyarylate fibers 70 are generally between 100 denier and 5000 denier, and may be in any orientation or pattern, knitted or unidirectional. Unlike woven fibers, unidirectional fibers are not intertwined, but rather may be laid out in alternating fiber orientation, as is known in the art. Also as is known in the art, knitted fibers are also not intertwined, but are stitched at a point of connection rather than being solely laid out in alternating orientation as are unidirectional fibers. It will be further understood by those skilled in the art that the fibers may be combined to form yarn, and that reference to fibers or fiber orientation and the like herein refer equally to yarns comprised of fibers. The ratio of polyester-polyarylate fibers 70 to rigid resin matrix material 12b′ can vary widely and can be tailored to the needs of a specific application.

The subject invention thus results in a high strength rigid radome or feedome with reduced radio frequency (RF) transmission losses and increased RF receiving sensitivity. The power requirements and cost of the antenna or communications systems protected by the radome are reduced by utilizing polyester-polyarylate fibers in a rigid matrix material in place of glass or quartz fibers or other currently known or used materials.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A radome or feedome comprising at least one rigid panel including composite material having polyester-polyarylate fibers in a rigid resin matrix material.

2. The radome or feedome of claim 1 in which the at least one rigid panel includes a first composite material skin having polyester-polyarylate fibers in a rigid resin matrix material.

3. The radome or feedome of claim 2 in which the at least one rigid panel includes second, opposing composite material skins having polyester-polyarylate fibers in a rigid resin matrix material and a core between the first and second composite material skins.

4. The radome or feedome of claim 3 in which the core is a low density material.

5. The radome or feedome of claim 1 in which the rigid resin matrix material is epoxy.

6. The radome or feedome of claim 1 in which the rigid resin matrix material is polyester.

7. The radome or feedome of claim 1 in which the rigid resin matrix material is polybutadiene.

8. The radome or feedome of claim 1 in which the rigid resin matrix material is cyanate ester.

9. The radome or feedome of claim 1 in which the rigid resin matrix material is vinyl ester.

10. The radome or feedome of claim 1 in which the rigid resin matrix material is a blend of at least two of: epoxy, polyester, polybutadiene, cyanate ester, and vinyl ester.

11. The radome or feedome of claim 1 in which the polyester-polyarylate fibers are between 100 denier and 5000 denier.

12. A radome or feedome comprising at least one rigid panel including composite material skins with polyester-polyarylate fibers in a rigid resin matrix material and a core therebetween.

13. A rigid radome or feedome with reduced radio frequency loss comprising:
a first skin including polyester-polyarylate fibers in a rigid resin matrix material;
a second skin including polyester-polyarylate fibers in a rigid resin matrix material; and
a core disposed between the first skin and the second skins.

14. The radome or feedome of claim 13 wherein the core is a low density material.

15. The radome or feedome of claim 13 wherein the rigid resin matrix material is epoxy.

16. The radome or feedome of claim 13 wherein the rigid resin matrix material is polyester.

17. The radome or feedome of claim 13 wherein the rigid resin matrix material is polybutadiene.

18. The radome or feedome of claim 13 wherein the rigid resin matrix material is cyanate ester.

19. The radome or feedome of claim 13 in which the rigid resin matrix material is vinyl ester.

20. The radome or feedome of claim 13 in which the rigid resin matrix material is a blend of at least two of: epoxy, polyester, polybutadiene, cyanate ester, and vinyl ester.

21. The radome or feedome of claim 13 in which the polyester-polyarylate fibers are between 100 denier and 5000 denier.

22. A method of producing a radome or feedome, the method comprising forming at least one rigid panel including composite material having polyester-polyarylate fibers in a rigid resin matrix.

23. The method of claim 22 wherein the at least one rigid panel includes a composite material skin having polyester-polyarylate fibers in a rigid resin matrix material.

24. A method of producing a radome or feedome, the method comprising:
forming a first skin comprised of polyester-polyarylate fibers in a rigid resin matrix;
forming a second skin comprised of polyester-polyarylate fibers in a rigid resin matrix;
disposing a core between the first and the second skins; and
bonding the skins to the core.
